(19) United States
(12) Patent Application Publication
(10) Pub. No.: US 2005/0269965 A1
(43) Pub. Date: Dec. 8, 2005

(54) Power unit, voltage control method and computer product

(75) Inventor: Kazunori Sato, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 11/126,226

(22) Filed: May 11, 2005

(30) Foreign Application Priority Data
May 13, 2004 (JP) 2004-143985

(51) Int. Cl. H05B 37/02

(52) U.S. Cl. 315/209 R

(57) ABSTRACT

A power unit includes a power source, a load, and a step-up circuit that connects the power source and the load. The step-up circuit includes a plurality of voltage step-up circuits. The voltage step-up circuits step up a voltage of the power source to a predetermined voltage, and apply the predetermined voltage to the load; A voltage control unit controls the voltage step-up circuits, and controls a power feedback unit to feed back power from the load to the power source when a voltage of the load detected by a voltage detecting unit exceeds the predetermined voltage.

### BACKGROUND OF THE INVENTION

1) Field of the Invention

The present invention relates to a technology for stabilizing voltage supply when feeding back power.

2) Description of the Related Art

Power units that include chopper-type step-up circuits or charge-pump circuits have been known in the art. These chopper-type step-up circuits or charge-pump circuits step up the voltage of a power source to a predetermined voltage Vo, and apply the stepped up voltage to a load. A voltage detecting unit detects the voltage of the load.

The voltage of the load occasionally rises higher than the voltage Vo because of external factors. One approach is to feed back the excess power (voltage) of the load to the power source. For example, Japanese Patent Application Laid Open No. 2003-89360 discloses such a technique and uses a single-phase chopper-type step-up circuit for the purpose. In this power unit, when a voltage of the load rises above a predetermined level, an n-MOS type field-effect transistor (hereinafter, “n-MOS type FET”) is switched on to feed back power of the load to the power source.

However, this technology can not be applied to a power unit that includes a plurality of chopper-type step-up circuits. FIG. 20 is a circuit schematic of a power unit 1h that includes a plurality of chopper-type step-up circuits. FIG. 21 is a timing chart of operations of n-MOS type FETs in the power unit 1h.

The power unit 1h includes a power source 5, a step-up circuit 10h that steps up a voltage of the power source 5 to a predetermined level and applies the stepped up voltage to a load 20. When the voltage V exceeds a predetermined voltage Vo, the excess power is fed back to the power source 5. For feeding back the excess power, a first power feedback switch 104 or a second power feedback switch 114 or both are switched on. While the power is being fed back, both of a first step-up switch 102 and a second step-up switch 112 are switched off to prevent a through current. However, when the first step-up switch 102 and the second step-up switch 112 are alternately driven at a duty cycle of 50% or more, either one is always switched on while the other is switched off, as shown in FIG. 21. Thus, a path of a through current is always formed as shown with a long-dashed line in FIG. 20, causing failures in the second step-up switch 112 and so forth. As a result, a stable voltage supply cannot be obtained.

### SUMMARY OF THE INVENTION

It is an object of the present invention to at least solve the problems in the conventional technology.

According to an aspect of the present invention, a power unit includes a power source; a load; a step-up circuit that connects the power source and the load and includes a plurality of voltage step-up circuits, wherein the voltage step-up circuits step up a voltage of the power source to a predetermined voltage and apply the predetermined voltage to the load; and a power feedback unit that feeds back power from the load to the power source; a voltage detecting unit that detects a voltage of the load; and a voltage control unit that controls the voltage step-up circuits so as to be cyclically driven one after the other, and controls the power feedback unit to feed back power from the load to the power source when a voltage of the load detected by the voltage detecting unit exceeds the predetermined voltage.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a circuit schematic of a power unit according to a first embodiment of the present invention;

FIG. 2 is a timing chart of the operation of step-up switches and power feedback switches of the power unit shown in FIG. 1;

FIG. 3 is a flowchart of a power feedback procedure performed by the power unit shown in FIG. 1;

FIG. 4 is a circuit schematic of a power unit according to a second embodiment of the present invention;

FIG. 5 is a flowchart of a power feedback procedure performed by the power unit shown in FIG. 4;

FIG. 6 is a circuit schematic of a power unit according to a third embodiment of the present invention;

FIG. 7 is a flowchart of a power feedback procedure performed by the power unit shown in FIG. 6;

FIG. 8 is a circuit schematic of a power unit according to a fourth embodiment of the present invention;

FIG. 9 is a flowchart of a power feedback procedure performed by the power unit shown in FIG. 8;

FIG. 10 is a circuit schematic of a power unit according to a fifth embodiment of the present invention;

FIG. 11 is a flowchart of a power feedback procedure performed by the power unit shown in FIG. 10;

FIG. 12 is a circuit schematic of a power unit according to a sixth embodiment of the present invention;

FIG. 13 is a flowchart of a power feedback procedure performed by the power unit shown in FIG. 12;

FIG. 14 is a circuit schematic of a power unit according to a seventh embodiment of the present invention;

FIG. 15 is a flowchart of a power feedback procedure performed by the power unit shown in FIG. 14;

FIG. 16 is a circuit schematic of a power unit according to a eighth embodiment of the present invention;

FIG. 17 is a flowchart of a power feedback procedure performed by the power unit shown in FIG. 16;

FIG. 18 is a circuit schematic of a variation of the power unit according to the second embodiment shown in FIG. 4;

FIG. 19 is a circuit schematic of a variation of the power unit according to the third embodiment shown in FIG. 6;

FIG. 20 is a circuit schematic of a conventional power unit that employs a plurality of chopper-type step-up circuits; and

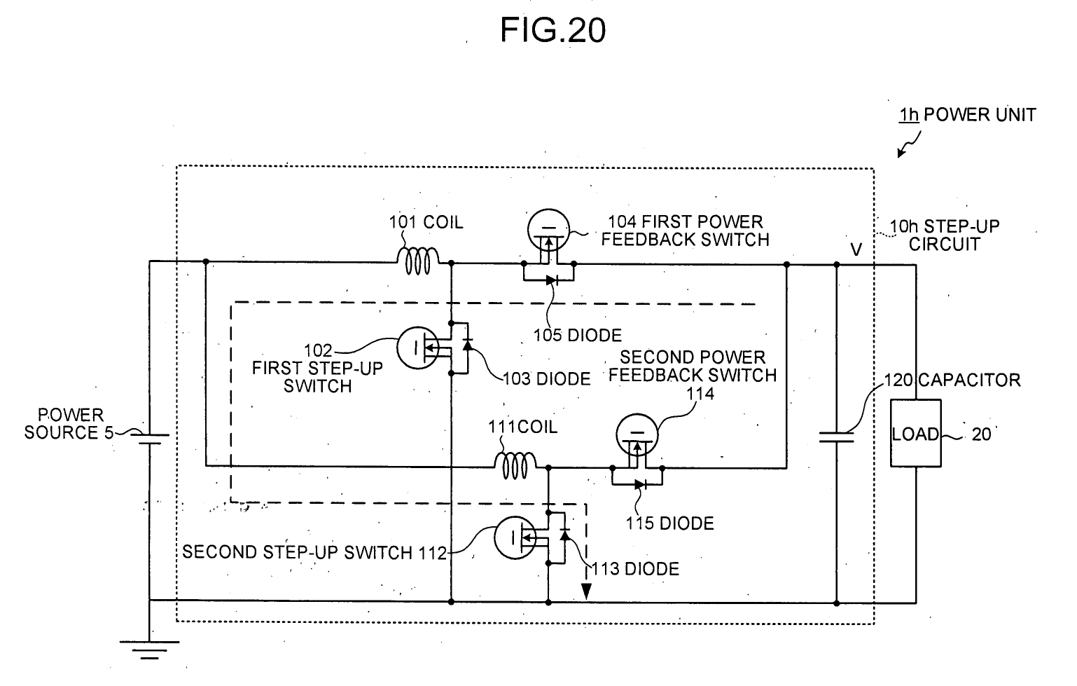

FIG. 21 is a timing chart of the operations of n-MOS type FETs in the power unit shown in FIG. 20.

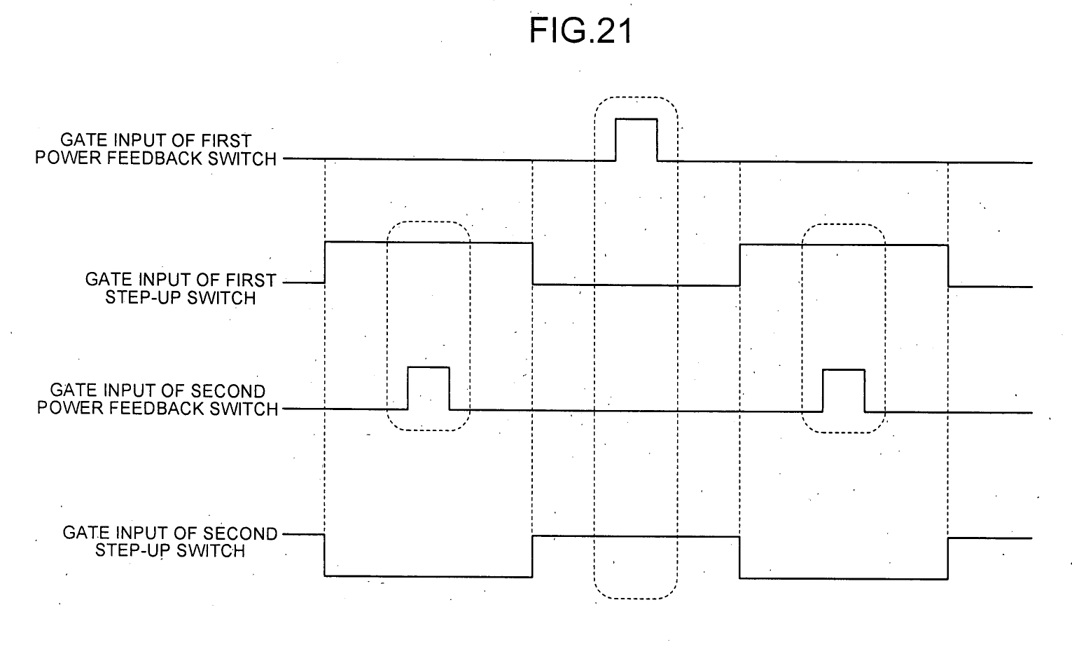

### DETAILED DESCRIPTION

Exemplary embodiments of the present invention will be described below with reference to accompanying drawings. Common components are denoted by the same reference numerals. A different small letter next to the same numeral means that there is a variation in the same component. Moreover, overlapping descriptions are omitted to avoid redundant explanations.

In a first embodiment according to the present invention, a plurality of chopper-type step-up circuits is used as power feedback circuits. Step-up switches in all of the chopper-type step-up circuits are switched off when feeding back power to cut off a through current.

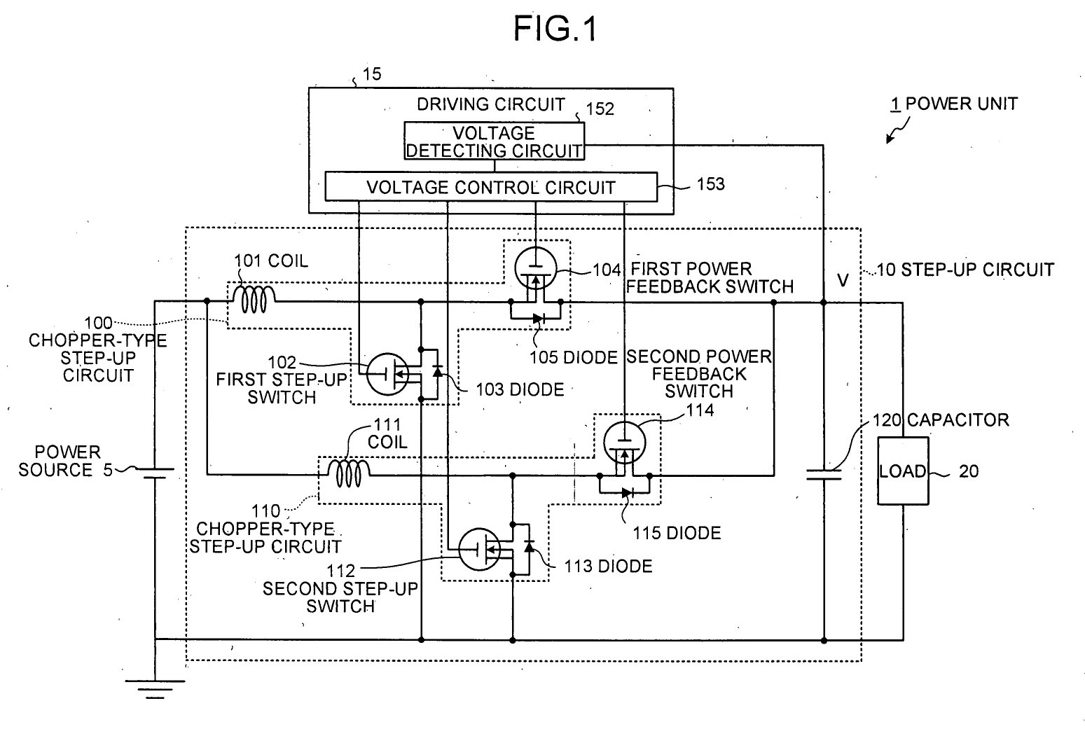

FIG. 1 is a circuit schematic of a power unit 1 according to the first embodiment. The power unit 1 includes a power source 5 that is a direct current power source, a step-up circuit 10, and a driving circuit 15. A load 20 is electrically connected to the power unit 1 and is driven by the power from the power unit 1.

The step-up circuit 10 includes a plurality of chopper-type step-up circuits 100, 110, and a capacitor 120. The chopper-type step-up circuit 100 and the chopper-type step-up circuit 110 step up a voltage of the power source 5 to a predetermined voltage Vo and apply the voltage Vo to the load 20.

The driving circuit 15 controls and drives the step-up circuit 10, and includes a voltage detecting circuit 152 and a voltage control circuit 153. The voltage detecting circuit 152 detects a voltage V of the load 20. The voltage control circuit 153 controls the chopper-type step-up circuit 100 and the chopper-type step-up circuit 110 to be alternately driven. One of the chopper-type step-up circuits is always driven. Moreover, the voltage control circuit 153 compares the voltage V and the predetermined voltage Vo. When the voltage V exceeds the voltage Vo, the voltage control circuit 153 controls the step-up circuit 10 to feed back power from the load 20 to the power source 5 through the chopper-type step-up circuit 100 and the chopper-type step-up circuit 110.

The chopper-type step-up circuit 100 includes a coil 101, a first step-up switch 102, a first power feedback switch 104, and diodes 103, 105. The chopper-type step-up circuit 110 includes a coil 111, a second step-up switch 112, a second power feedback switch 114, and diodes 113, 115.

The coils 101, 111 are connected at one terminal to the power source 5 so that a voltage of the power source 5 is applied to the coils 101, 111. When the first step-up switch 102 or the second step-up switch 112 is switched on, the coil 101 or the coil 111 is excited (i.e., energy is accumulated in the coil 101 or the coil 111). When the first step-up switch 102 or the second step-up switch 112 is switched off, magnetic flux of the coil 101 or the coil 111 changes, and the energy accumulated is released to the load 20, thus applying a stepped up voltage to the load 20. The coils 101, 111 are connected at the other terminal to the first power feedback switch 104 and the second power feedback switch 114, respectively.

The first power feedback switch 104 and the second power feedback switch 114 are switched on to feed back power from the load 20 to the power source 5. The first step-up switch 102, the second step-up switch 112, the first power feedback switch 104, and the second power feedback switch 114 are n-MOS type FET semiconductor switches. The diodes 103, 105, 113, and 115 are rectifier diodes. The capacitor 120 is a smoothing capacitor that smoothes the stepped up voltage, and supplies the smoothed voltage to the load 20. The first power feedback switch 104 and the second power feedback switch 114 include the diodes 105, 115, respectively, as parasitic diodes.

The first power feedback switch 104 and the second power feedback switch 114 are described as components of the step-up circuit 10, because the step-up circuit 10 uses these diodes 105, 115. Further, because the step-up circuit 10 includes the first power feedback switch 104 and the second power feedback switch 114, the step-up circuit 10 functions as a power feedback circuit.

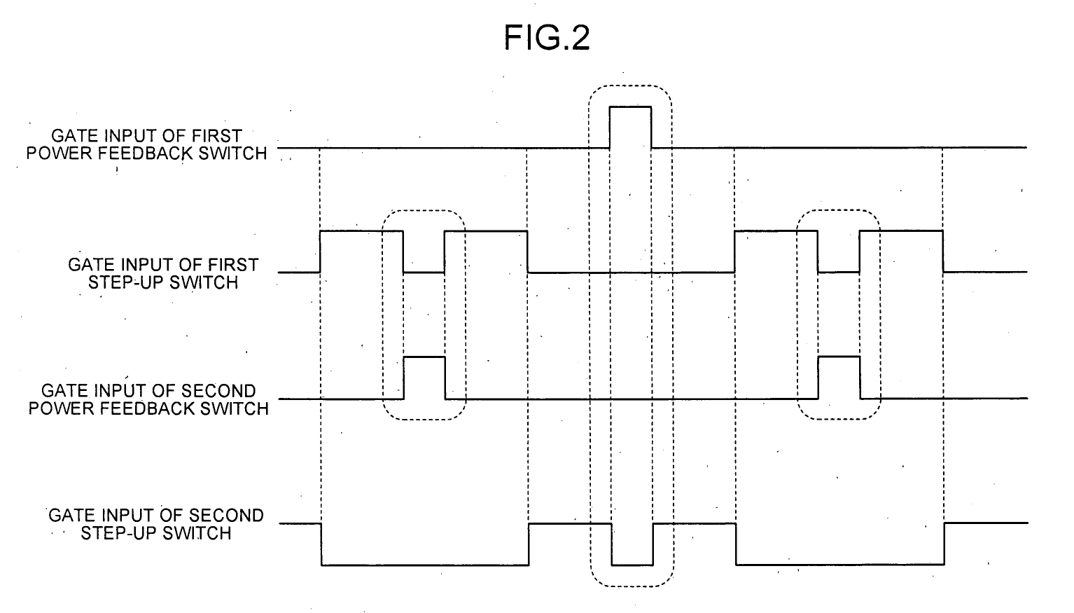

FIG. 2 is a timing chart of the operations of the first step-up switch 102, the second step-up switch 112, the first power feedback switch 104, and the second power feedback switch 114 of the power unit 1.

The first step-up switch 102 and the second step-up switch 112 are alternately driven at a duty cycle of 50%. Specifically, the phases of the first step-up switch 102 and the second step-up switch 112 are 180 degrees different, such that either one of the step-up switches is always switched on when the other one is switched off. The first step-up switch 102 and the second step-up switch 112 can be driven at duty cycles of more than or less than 50%.

When the voltage V exceeds the voltage Vo, the voltage control circuit 153 switches off the step-up switch that is in an on state, so that both the first step-up switch 102 and the second step-up switch 112 are in an off state. The voltage control circuit 153 then switches on the first power feedback switch 104 or the second power feedback switch 114 in the chopper-type step-up circuit including the step-up switch that is in an off state (i.e., that did not need to be switched off). Thus, power of the load 20 is fed back to the power source 5 through the chopper-type step-up circuit 100 or the chopper-type step-up circuit 110. Therefore, a through current is prevented from flowing through a chopper-type step-up circuit other than the one used as the power feedback circuit.

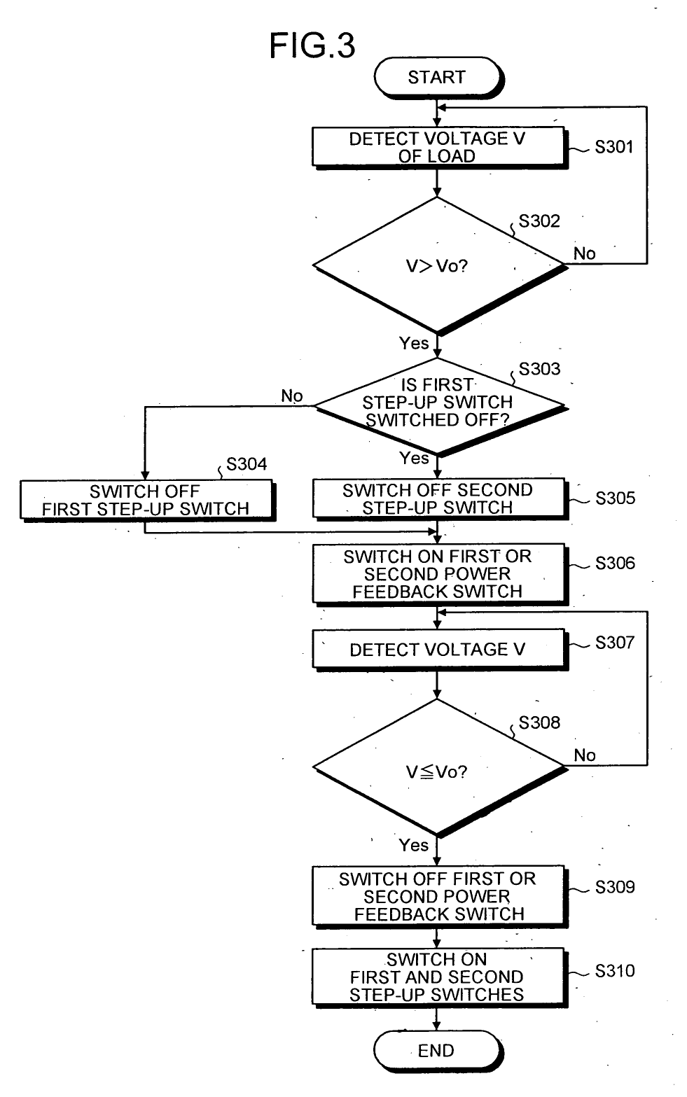

FIG. 3 is a flowchart of a power feedback procedure performed by the power unit 1. When the power unit 1 is booted, the voltage detecting circuit 152 detects a voltage V of the load 20 (step S301). The voltage control circuit 153 checks whether the voltage V exceeds the predetermined voltage Vo (step S302). When the voltage V does not exceed the voltage Vo (No at step S302), the procedure returns to step S301. On the other hand, when the voltage V exceeds the voltage Vo (Yes at step S302), the voltage control circuit 153 checks whether the first step-up switch 102 is in an off state (step S303). When the first step-up switch 102 is not in an off state (No at step S303), the voltage control circuit 153 switches off the first step-up switch 102 (step S304). On the other hand, when the first step-up switch 102 is in an off state (Yes at step S303) the voltage control circuit 153 switches off the second step-up switch 112 (step S305).

The voltage control circuit 153 then switches on either one of the first power feedback switch 104 or the second power feedback switch 114 (step S306) in the chopper-type step-up circuit including the step-up switch that is in an off state (i.e., that did not need to be switched off at step S304 or S305). The voltage detecting circuit 152 detects the voltage V (step S307). The voltage control circuit 153 checks whether the voltage V is equal to or less than the voltage Vo (step S308). When the voltage V is not equal to or less than the voltage Vo (No at step S308), the procedure returns to step S307. On the other hand, when the voltage V is equal to or less than the voltage Vo (Yes at step S308), the voltage control circuit 153 switches off the first power feedback switch 104 or the second power feedback switch 114 switched on at step S306 (step S309), and switches on the first step-up switch 102 and the second step-up switch 112 (step S310), and the procedure ends.

Accordingly, while power is fed back from the load 20 to the power source 5 through the step-up circuit 10, a through current is prevented from flowing into circuit components. Therefore, failures in the circuit components are prevented and voltage supply is stabilized.

The first power feedback switch 104 and the second power feedback switch 114 are semiconductor switches or electromagnetic-mechanical switches that are readily available.

The voltage control circuit 153 controls the first power feedback switch 104 and the second power feedback switch 114 using a pulse-width modulation (PWM) technique. Therefore, loads on the semiconductor switches, harnesses, and so forth, are alleviated.

In a second embodiment of the present invention, a plurality of chopper-type step-up circuits is used as power feedback circuits. Switches are provided in the chopper-type step-up circuits to cut off a through current.

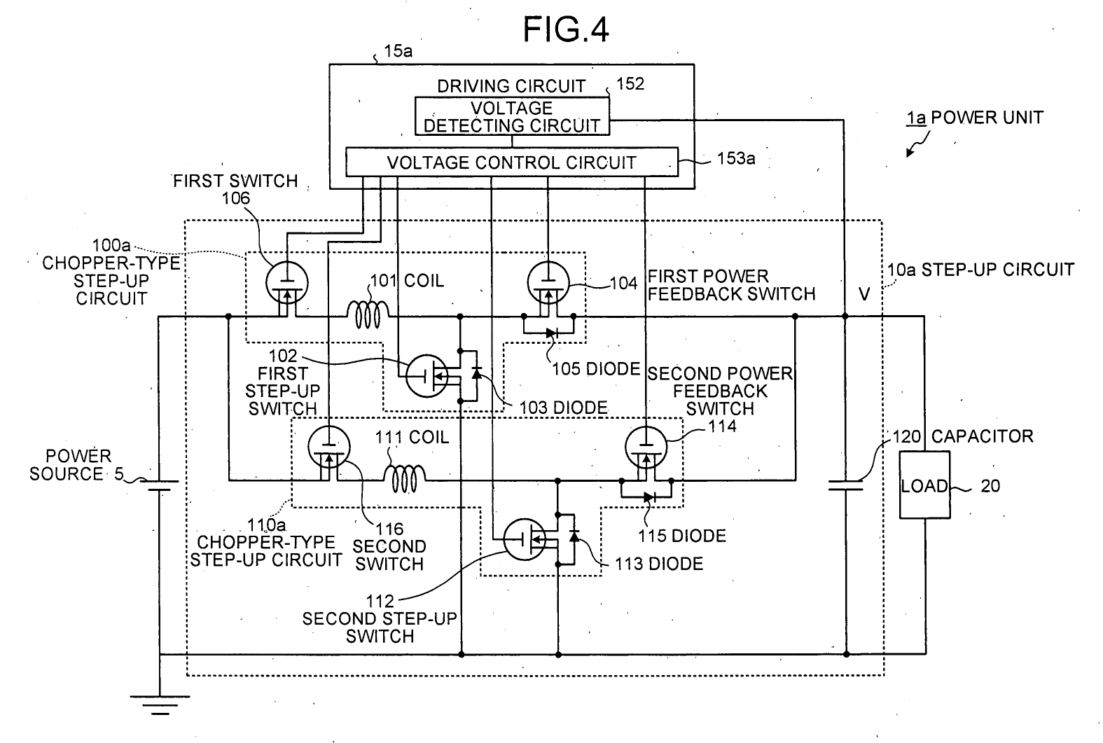

FIG. 4 is a circuit schematic of a power unit 1a according to the second embodiment. The main difference between the first embodiment (FIG. 1) and the second embodiment (FIG. 4) is that, in a step-up circuit 10a, a first switch 106 and a second switch 116 are provided in a chopper-type step-up circuit 100a and a chopper-type step-up circuit 110a, respectively. The first switch 106 and the second switch 116 are provided on lines connecting the coils 101, 111 and the power source 5. The first switch 106 and the second switch 116 are always switched on, except when power is fed back from the load 20 to the power source 5. The first switch 106 and the second switch 116 are n-MOS type FET semiconductor switches.

When the voltage V exceeds the voltage Vo, a voltage control circuit 153a included in a driving circuit 15a checks which one of the first step-up switch 102 or the second step-up switch 112 is switched on. The voltage control circuit 153a switches off either the first switch 106 or the second switch 116 in the chopper-type step-up circuit 100a or the chopper-type step-up circuit 110a including the step-up switch that is in an on state. The switch in the chopper-type step-up circuit including the other step-up switch that is in an off state does not need to be switched off. The voltage control circuit 153a then switches on the first power feedback switch 104 or the second power feedback switch 114 in the chopper-type step-up circuit including the other step-up switch that is in an off state. Therefore, while power is fed back through the chopper-type step-up circuit 100a or the chopper-type step-up circuit 110a, a through current is prevented from flowing into circuit components.

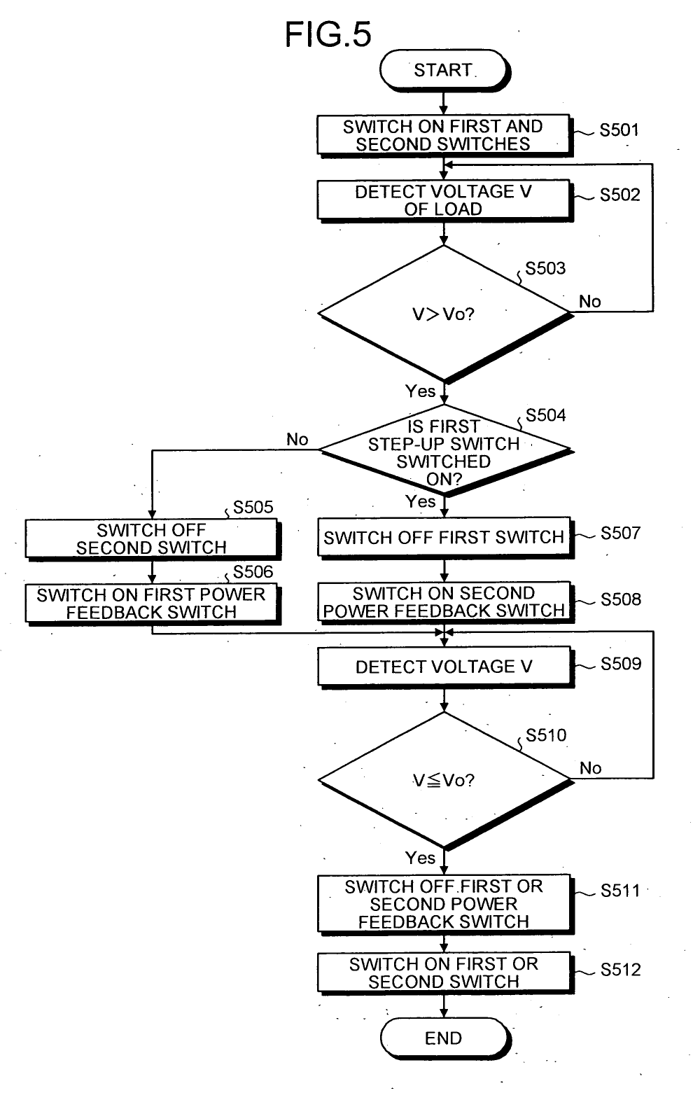

FIG. 5 is a flowchart of a power feedback procedure performed by the power unit 1a. When the power unit 1a is booted, the voltage control circuit 153a switches on the first switch 106 and the second switch 116 (step S501). The voltage detecting circuit 152 then detects a voltage V of the load 20 (step S502). The voltage control circuit 153a checks whether the voltage V exceeds the voltage Vo (step S503). When the voltage V does not exceed the voltage Vo (No at step S503), the procedure returns to step S502. On the other hand, when the voltage V exceeds the voltage Vo (Yes at step S503), the voltage control circuit 153a checks whether the first step-up switch 102 is in an on state (step S504). When the first step-up switch 102 is not in an on state (No at step S504), it means that the second step-up switch 112 is in an on state. Thus, the voltage control circuit 153a switches off the second switch 116 (step S505), and switches on the first power feedback switch 104 (step S506). On the other hand, when the first step-up switch 102 is in an on state (Yes at step S504), the voltage control circuit 153a switches off the first switch 106 (step S507), and switches on the second power feedback switch 114 (step S508).

The voltage detecting circuit 152 detects the voltage V (step S509). The voltage control circuit 153a checks whether the voltage V is equal to or less than the voltage Vo (step S510). When the voltage V is not equal to or less than the voltage Vo (No at step S510), the procedure returns to step S509. On the other hand, when the voltage V is equal to or less than the voltage Vo (Yes at step S510), the voltage control circuit 153a switches off the first power feedback switch 104 or the second power feedback switch 114 (step S511), and switches on the first switch 106 or the second switch 116 (step S512), and the procedure ends.

Accordingly, while power is fed back from the load 20 to the power source 5 through the step-up circuit 10a, a through current is prevented from flowing into circuit components. Therefore, failures in the circuit components are prevented so that a stable voltage supply is obtained.

The first switch 106 and the second switch 116 are semiconductor switches or electromagnetic-mechanical switches that are readily available.

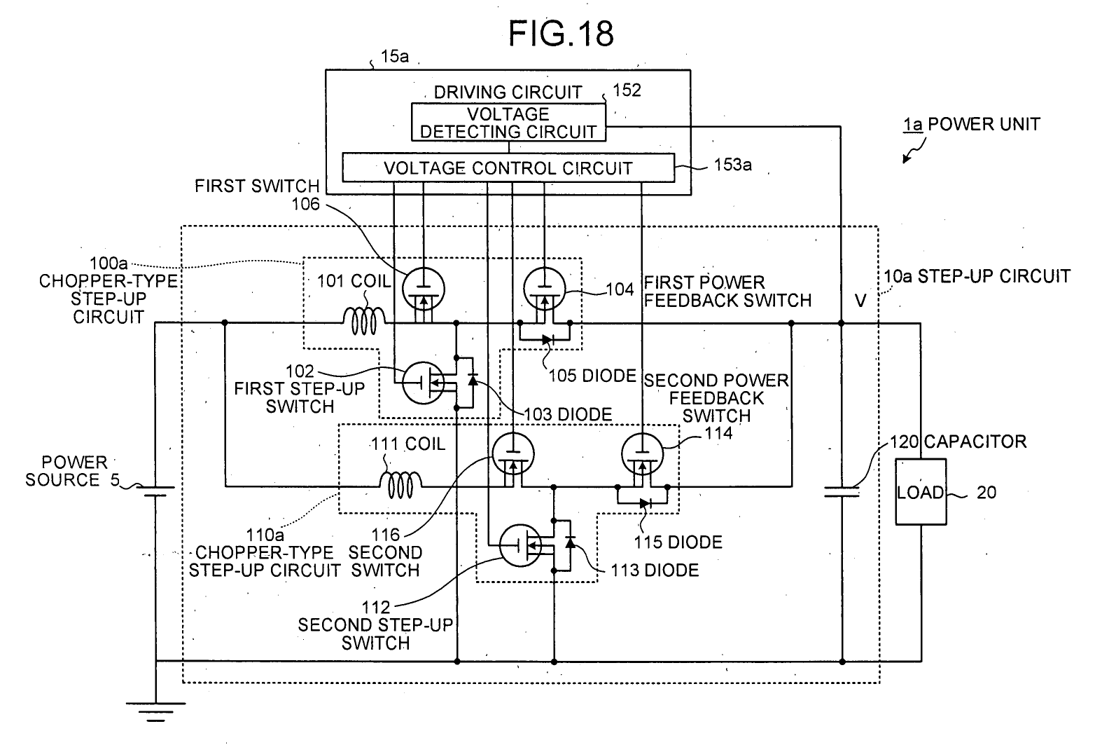

FIG. 18 is a circuit schematic of a different version of the power unit 1a according to the second embodiment of the present invention. The difference between the second embodiment (FIG. 4) and the different version (FIG. 18) is only in the positions of the first switch 106 and the second switch 116.

In a third embodiment of the present embodiment, among a plurality of chopper-type step-up circuits, a predetermined chopper-type step-up circuit is used as a power feedback circuit. A switch is provided to cut off a through current.

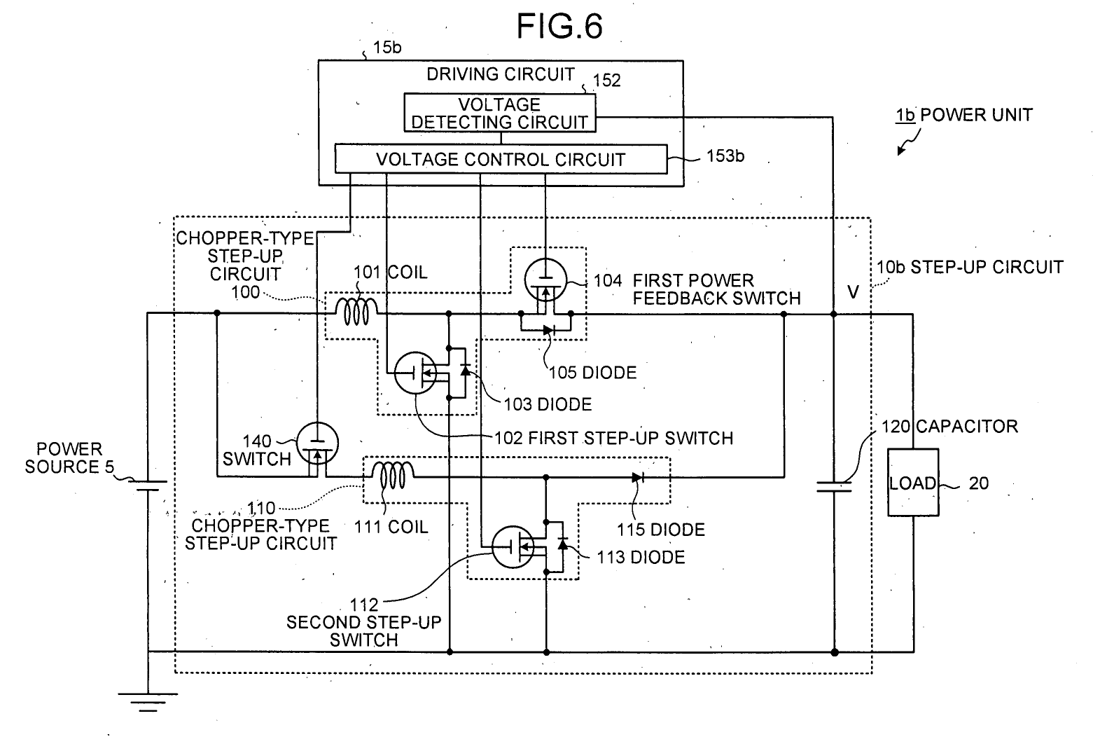

FIG. 6 is a circuit schematic of a power unit 1b according to the third embodiment. There are two differences between the first embodiment (FIG. 1) and the third embodiment (FIG. 6). The first is that a switch 140 is provided in a step-up circuit 10b. The switch 140 is provided outside of the chopper-type step-up circuits, and connects the coil 111 in the chopper-type step-up circuit 110 and the power source 5. The second is that the chopper-type step-up circuit 110 does not include the second power feedback switch 114. The switch 140 is always switched on, except when power is fed back from the load 20 to the power source 5. The switch 140 is an n-MOS type FET semiconductor switch.

When the voltage V exceeds the voltage Vo, a voltage control circuit 153b included in a driving circuit 15b switches on the first power feedback switch 104 to feed back power from the load 20 to the power source 5 through the chopper-type step-up circuit 100. At the same time, the voltage control circuit 153b switches off the switch 140 so that a through current is prevented from flowing into the chopper-type step-up circuit 110.

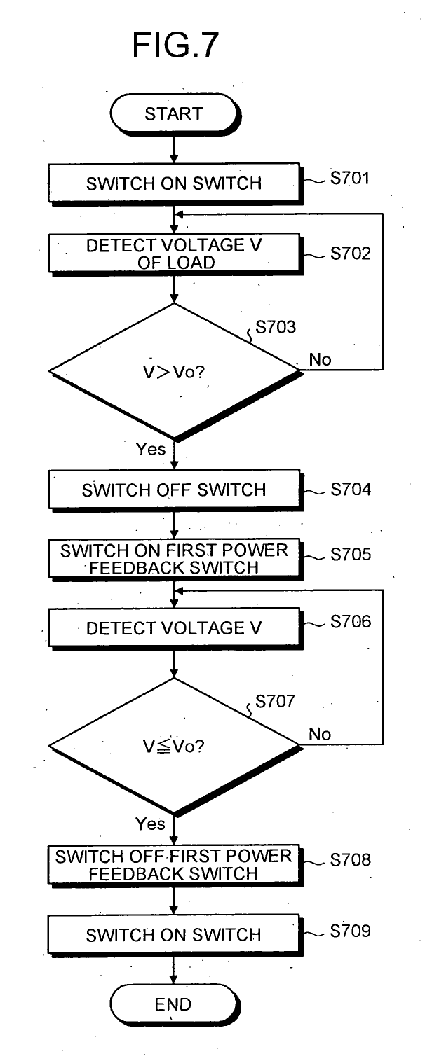

FIG. 7 is a flowchart of a power feedback procedure performed by the power unit 1b. When the power unit 1b is booted, the voltage control circuit 153b switches on the switch 140 (step S701). The voltage detecting circuit 152 then detects a voltage V of the load 20 (step S702). The voltage control circuit 153b checks whether the voltage V exceeds the voltage Vo (step S703). When the voltage V does not exceed the voltage Vo (No at step S703), the procedure returns to step S702. On the other hand, when the voltage V exceeds the voltage Vo (Yes at step S703), the voltage control circuit 153b switches off the switch 140 (step S704), and switches on the first power feedback switch 104 (step S705).

The voltage detecting circuit 152 detects the voltage V (step S706). The voltage control circuit 153b checks whether the voltage V is equal to or less than the voltage Vo (step S707). When the voltage V is not equal to or less than the voltage Vo (No at step S707), the procedure returns to step S706 to detect the voltage V. On the other hand, when the voltage V is equal to or less than the voltage Vo (Yes at step S707), the voltage control circuit 153b switches off the first power feedback switch 104 (step S708), and switches on the switch 140 (step S709), and the procedure ends.

Accordingly, while power is fed back from the load 20 to the power source 5 through the step-up circuit 10b, a through current is prevented from flowing into circuit components, thus preventing failures in the circuit components and stabilizing voltage supply.

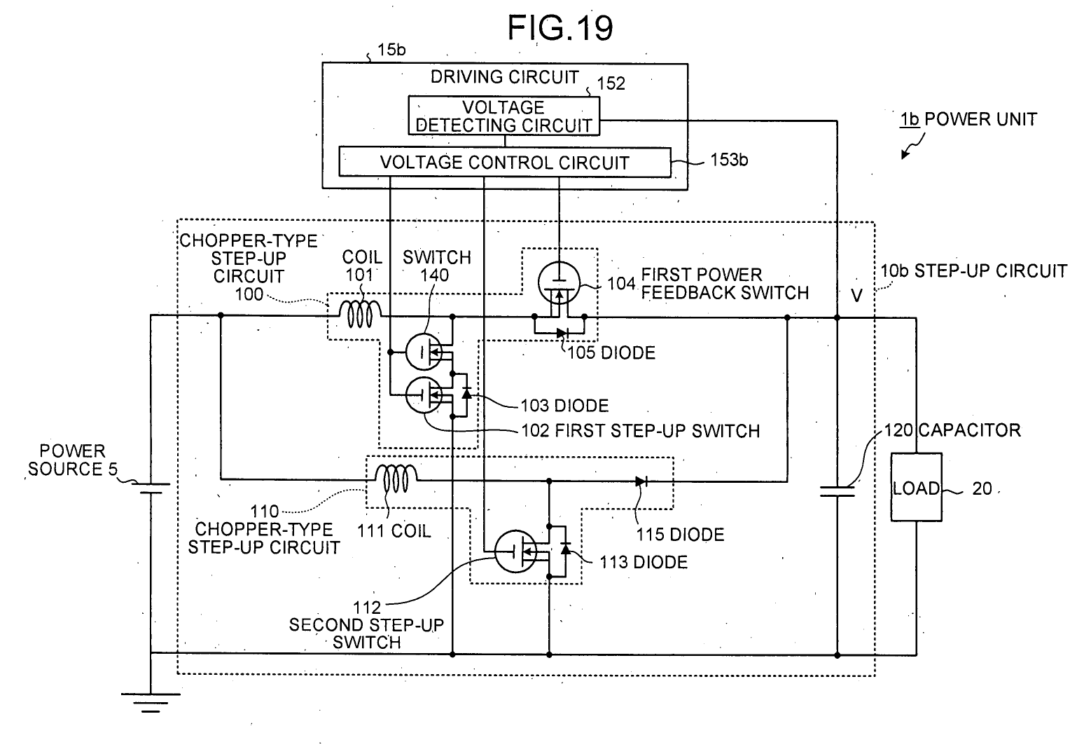

FIG. 19 is a circuit schematic a different version of the power unit 1b according to the third embodiment. The difference between the third embodiment (FIG. 6) and the different version (FIG. 19) is only in position of the switch 140.

In a fourth embodiment of the present invention, a designated power feedback circuit is provided in addition to a plurality of chopper-type step-up circuits.

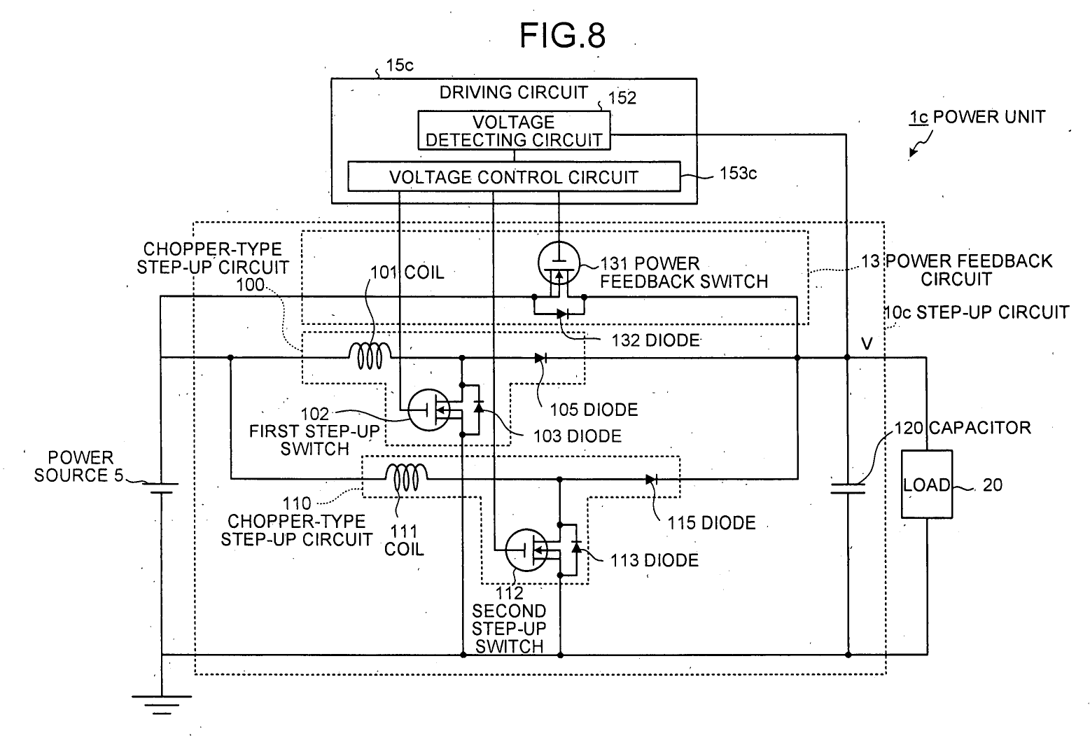

FIG. 8 is a circuit schematic of a power unit 1c according to the fourth embodiment. The main difference between the first embodiment (FIG. 1) and the fourth embodiment (FIG. 8) is that, in a step-up circuit 10c, a power feedback circuit 13 including a power feedback switch 131 and a diode 132 is provided separately from the chopper-type step-up circuit 100 and the chopper-type step-up circuit 110. The power feedback circuit 13 connects the power source 5 and the load 20. Moreover, the chopper-type step-up circuit 100 and the chopper-type step-up circuit 110 do not include the first power feedback switch 104 and the second power feedback switch 114. The power feedback switch 131 is an n-MOS type FET semiconductor switch.

When the voltage V exceeds the voltage Vo, a voltage control circuit 153c included in a driving circuit 15c switches on the power feedback switch 131 to feed back the power of the load 20 to the power source 5 through the power feedback circuit 13.

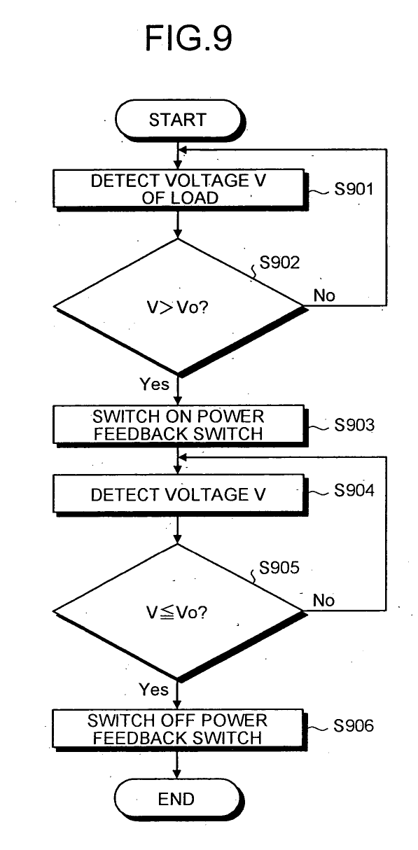

FIG. 9 is a flowchart of a power feedback procedure performed by the power unit 1c. When the power unit 1c is booted, the voltage detecting circuit 152 detects a voltage V of the load 20 (step S901). The voltage control circuit 153c checks whether the voltage V exceeds the voltage Vo (step S902). When the voltage V does not exceed the voltage Vo (No at step S902), the procedure returns to step S901 to detect the voltage V. On the other hand, when the voltage V exceeds the voltage Vo (Yes at step S902), the voltage control circuit 153c switches on the power feedback switch 131 (step S903). The voltage detecting circuit 152 detects the voltage V (step S904). The voltage control circuit 153c checks whether the voltage V is equal to or less than the voltage Vo (step S905). When the voltage V is not equal to or less than the voltage Vo (No at step S905), the procedure returns to step S904. On the other hand, when the voltage V is equal to or less than the voltage Vo (Yes at step S905), the voltage control circuit 153c switches off the power feedback switch 131 (step S906), and the procedure ends.

Accordingly, while power is fed back from the load 20 to the power source 5 through the power feedback circuit 13, a through current is prevented from flowing into circuit components. Therefore, failures in the circuit components are prevented so that a stable voltage supply is obtained.

In a fifth embodiment of the present invention, a power source corresponding to each of the plurality of the chopper-type step-up circuits is provided. Each chopper-type step-up circuit is driven by a different power source.

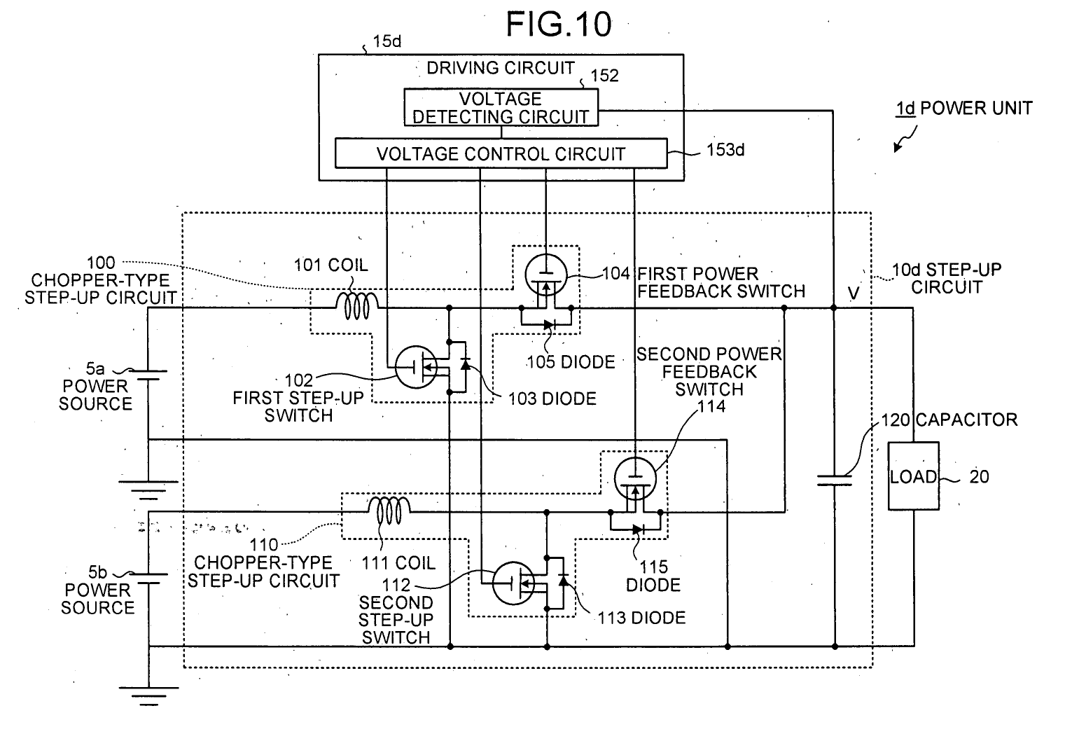

FIG. 10 is a circuit schematic of a power unit 1d according to the fifth embodiment. The main difference between the first embodiment (FIG. 1) and the fifth embodiment (FIG. 10) is that the chopper-type step-up circuit 100 and the chopper-type step-up circuit 110 are connected to corresponding power sources 5a and 5b.

When the voltage V exceeds the voltage Vo, a voltage control circuit 153d included in a driving circuit 15d switches on either the first power feedback switch 104 or the second power feedback switch 114, to feed back power from the load 20 to either the power source 5a or the power source 5b, through a step-up circuit 10d. The power is fed back through either the chopper-type step-up circuit 100 or the chopper-type step-up circuit 110 that includes the first step-up switch 102 or the second step-up switch 112 in an off state.

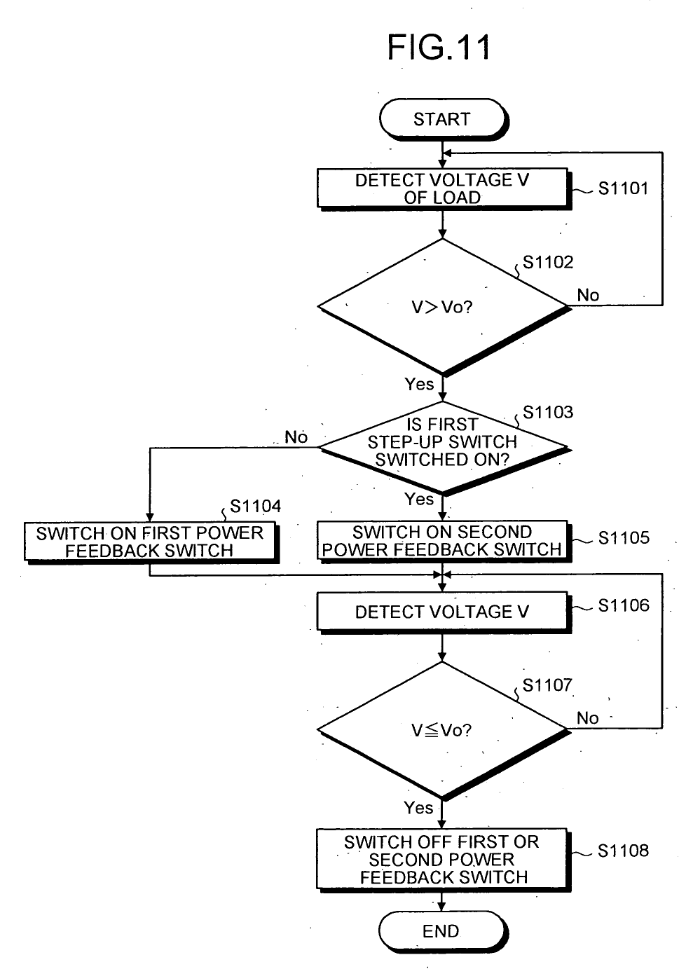

FIG. 11 is a flowchart of a power feedback procedure performed by the power unit 1d. When the power unit 1d is booted, the voltage detecting circuit 152 detects a voltage V of the load 20 (step S1101). The voltage control circuit 153d checks whether the voltage V exceeds the voltage Vo (step S1102). When the voltage V does not exceed the voltage Vo (No at step S1102), the procedure returns to step S1101 to detect the voltage V of the load 20. On the other hand, when the voltage V exceeds the voltage Vo (Yes at step S1102), the voltage control circuit 153d checks whether the first step-up switch 102 is in an on state (step S1103). When the first step-up switch 102 is not in an on state (No at step S1103), the voltage control circuit 153d switches on the first power feedback switch 104 (step S1104). On the other hand, when the first step-up switch 102 is in an on state (Yes at step S1103), it means that the second step-up switch 112 is in an off state. Thus, the voltage control circuit 153d switches on the second power feedback switch 114 (step S1105).

The voltage detecting circuit 152 detects the voltage V (step S1106). The voltage control circuit 153d checks whether the voltage V is equal to or less than the voltage Vo (step S1107). When the voltage V is not equal to or less than the voltage Vo (No at step S1107), the procedure returns to step S1106. On the other hand, when the voltage V is equal to or less than the voltage Vo (Yes at step S1107), the voltage control circuit 153d switches off either the first power feedback switch 104 or the second power feedback switch 114 (step S1108), and the procedure ends.

Accordingly, while power is fed back from the load 20 to either one of the power source 5a or the power source 5b through the step-up circuit 10d, a through current is prevented from flowing into circuit components. Therefore, failures in the circuit components are prevented so that a stable voltage supply is obtained.

In a sixth embodiment according to the present embodiment, a predetermined chopper-type step-up circuit is used as a power feedback circuit, and a switch is provided to cut off a through current from flowing into a plurality of chopper-type step-up circuits.

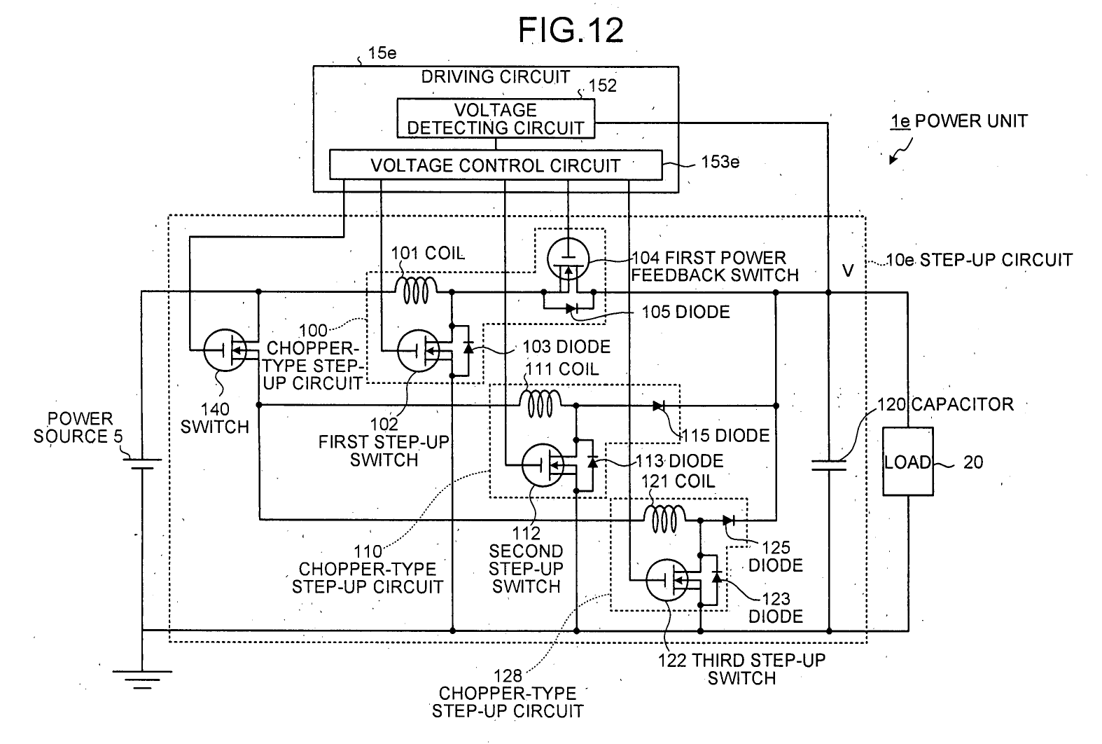

FIG. 12 is a circuit schematic of a power unit 1e according to the sixth embodiment. The main difference between the first embodiment (FIG. 1) and the sixth embodiment (FIG. 12) is that there are three chopper-type step-up circuits in the sixth embodiment. These are the chopper-type step-up circuit 100, the chopper-type step-up circuit 110, and a chopper-type step-up circuit 128, in a step-up circuit 10e. Among these, the chopper-type step-up circuit 100 is designated as the power feedback circuit, and includes the first power feedback switch 104. The chopper-type step-up circuit 110 and the chopper-type step-up circuit 128 do not include power feedback switches. The chopper-type step-up circuit 128 includes a step-up switch 122, and diodes 125, 123. Another difference between the first embodiment is that the switch 140 is connected to the chopper-type step-up circuits 100, 110 and 128. The switch 140 is always switched on, except when power is fed back from the load 20 to the power source 5. The switch 140 is an n-MOS type FET semiconductor switch.

When the voltage V exceeds the voltage Vo, a voltage control circuit 153e included in a driving circuit 15e switches on the first power feedback switch 104 to feed back power from the load 20 to the power source 5 through the chopper-type step-up circuit 100. At the same time, the voltage control circuit 153e switches off the switch 140 so that a through current is prevented from flowing into the chopper-type step-up circuit 110 and the chopper-type step-up circuit 128.

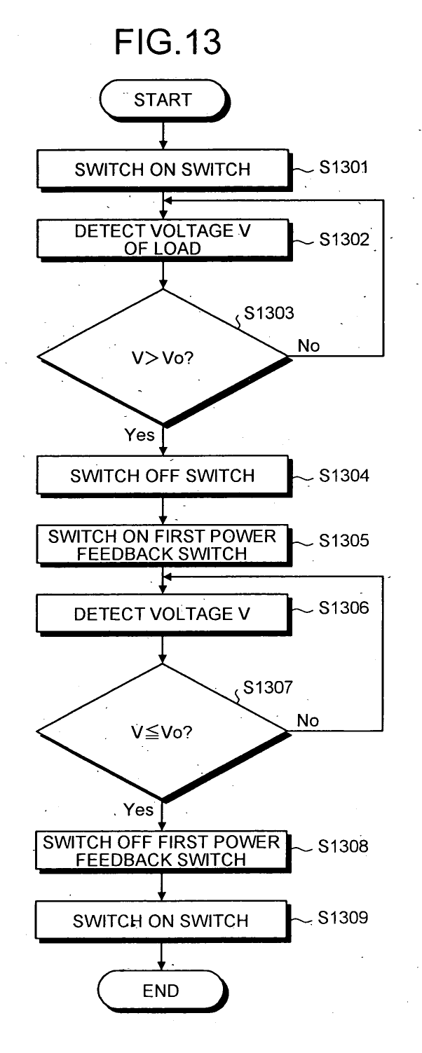

FIG. 13 is a flowchart of a power feedback procedure performed by the power unit 1e. When the power unit 1e is booted, the voltage control circuit 153e switches on the switch 140 (step S1301). The voltage detecting circuit 152 detects a voltage V of the load 20 (step S1302). The voltage control circuit 153e checks whether the voltage V exceeds the voltage Vo (step S1303). When the voltage V does not exceed the voltage Vo (No at step S1303), the procedure returns to step S1302. On the other hand, when the voltage V exceeds the voltage Vo (Yes at step S1303), the voltage control circuit 153e switches off the switch 140 (step S1304), and switches on the first power feedback switch 104 (step S1305).

The voltage detecting circuit 152 detects the voltage V (step S1306). The voltage control circuit 153e checks whether the voltage V is equal to or less than the voltage Vo (step S1307). When the voltage V is not equal to or less than the voltage Vo (No at step S1307), the procedure returns to step S1306. On the other hand, when the voltage V is equal to or less than the voltage Vo (Yes at step S1307), the voltage control circuit 153e switches off the first power feedback switch 104 (step S1308) and switches on the switch 140 (step S1309), and the procedure ends.

Accordingly, while power is fed back from the load 20 to the power source 5 through the step-up circuit 10e, a through current is prevented from flowing into circuit components. Therefore, failures in the circuit components are prevented so that a stable voltage supply is obtained.

In a seventh embodiment of the present invention, a designated power feedback circuit is provided in addition to a plurality of charge-pump circuits.

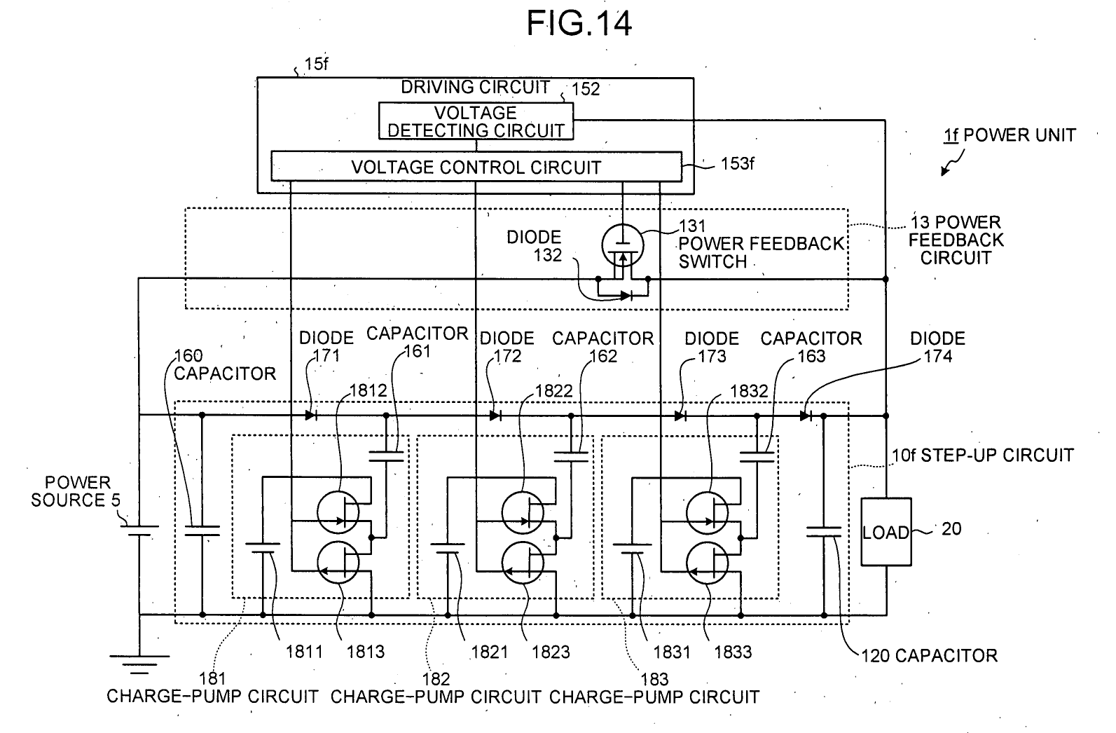

FIG. 14 is a circuit schematic of a power unit 1f according to the seventh embodiment. The main differences between the first embodiment (FIG. 1) and the seventh embodiment (FIG. 14) are that the power feedback circuit 13 is provided outside of a step-up circuit 10f, and that the step-up circuit 10f includes charge-pump circuits instead of chopper-type step-up circuits. The power feedback circuit 13 includes the power feedback switch 131 and the diode 132. The step-up circuit 10f includes the capacitor 120, a capacitor 160, diodes 171 to 174, and charge-pump circuits 181, 182, and 183. The capacitor 160 holds a voltage of the power source 5. The diodes 171 to 174 are rectifier diodes.

The charge-pump circuit 181 includes a capacitor 161, a charge-pump power source 1811, an on-switch that is an n-channel junction field-effect transistor 1812, and an off-switch that is a p-channel junction field-effect transistor 1813. The charge-pump circuit 182 includes a capacitor 162, a charge-pump power source 1821, an on-switch 1822, and an off-switch 1823. The charge-pump circuit 183 includes a capacitor 163, a charge-pump power source 1831, an on-switch 1832, and an off-switch 1833. The capacitor 120 is a smoothing capacitor. The charge-pump circuits 181, 182, and 183 can employ bipolar transistors instead of the junction FETs.

The capacitors 161, 162, and 163 have first and second terminals. A voltage of the power source 5 is applied to the second terminals. The first terminals are controlled as follows. A voltage control circuit 153f included in a driving circuit 15f transmits an on control signal or an off control signal to the charge-pump circuit 181. When an off control signal is received, the off-switch 1813 operates so that a ground potential at the first terminal of the capacitor 161 decreases, and the capacitor 161 is electrically charged. When an on control signal is received, the on-switch 1812 operates so that the ground potential at the first terminal of the electrically charged capacitor 161 increases by an amount corresponding to the potential of the charge-pump power source 1811. Therefore, a potential of an anode terminal of the diode 171 increases. In this manner, the voltage control circuit 153f sequentially operates the charge-pump circuits 181, 182, and 183 from the left side to the right side as viewed in FIG. 14, so as to sequentially increase the anode-side voltages of the rectifier diodes 171, 172, and 173. Consequently, the voltage Vo is applied to the load 20.

When the voltage V exceeds the voltage Vo, the voltage control circuit 153f grounds the second terminals of all of all of the capacitors 161, 162, and 163. Thus, a voltage of the capacitor 120 decreases so that an overvoltage breakdown is prevented. The voltage control circuit 153f then switches on the power feedback switch 131 to feed back power from the load 20 to the power source 5.

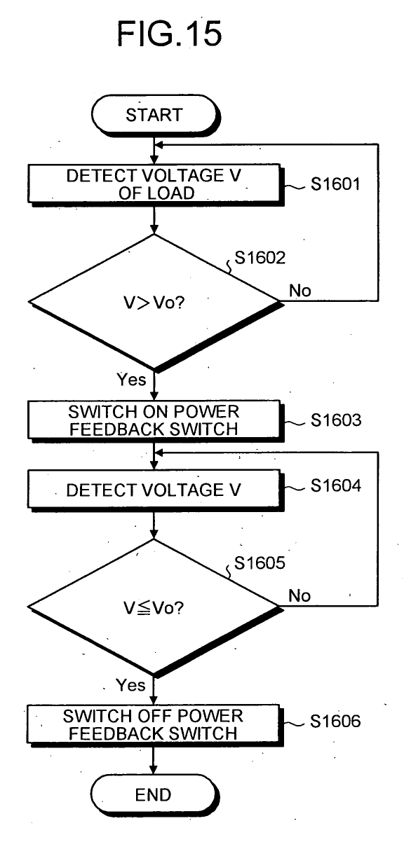

FIG. 15 is a flowchart of a power feedback procedure performed by the power unit 1f. When the power unit 1f is booted, the voltage detecting circuit 152 detects a voltage V of the load 20 (step S1601). The voltage control circuit 153f checks whether the voltage V exceeds the voltage Vo (step S1602). When the voltage V does not exceed the voltage Vo (No at step S1602), the procedure returns to step S1601 to detect the voltage V. On the other hand, when the voltage V exceeds the voltage Vo (Yes at step S1602), the voltage control circuit 153f switches on the power feedback switch 131 (step S1603).

The voltage detecting circuit 152 detects the voltage V (step S1604). The voltage control circuit 153f checks whether the voltage V is equal to or less than the voltage Vo (step S1605). When the voltage V is not equal to or less than the voltage Vo (No at step S1605), the procedure returns to step S1604. On the other hand, when the voltage V is equal to or less than the voltage Vo (Yes at step S1605), the voltage control circuit 153f switches off the power feedback switch 131 (step S1606), and the procedure ends.

Accordingly, while power is fed back from the load 20 to the power source 5 through the power feedback circuit 13, an overvoltage breakdown in a smoothing capacitor is prevented. Therefore, failures in the circuit components are prevented so that a stable voltage supply is obtained.

Moreover, the voltage control circuit 153f controls the power feedback switch 131 using the PWM technique, so that the power is gradually fed back from the load 20 to the power source 5. Therefore, failures in the circuit components are prevented so that a stable voltage supply is obtained.

In an eighth embodiment of the present invention, a plurality of charge-pump circuits is used as a power feedback circuit.

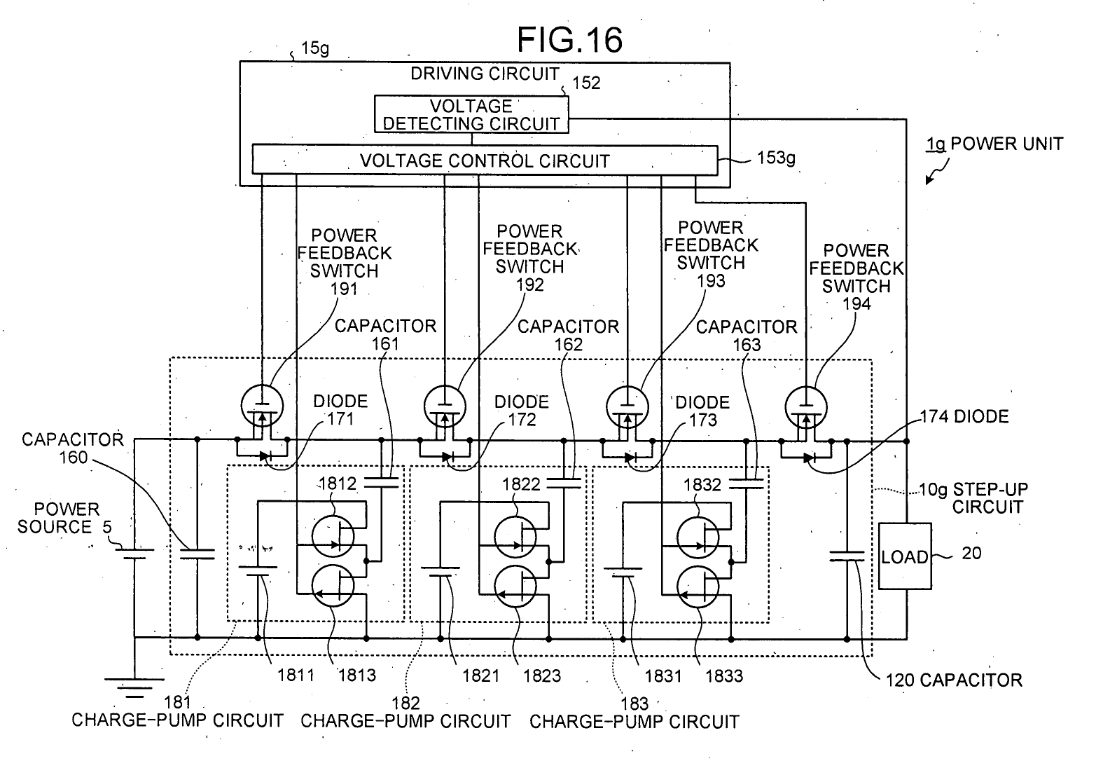

FIG. 16 is a circuit schematic of a power unit 1g according to the eighth embodiment. The main difference between the seventh embodiment (FIG. 14) and the eighth embodiment (FIG. 16) is that power feedback switches 191 to 194 are provided inside a step-up circuit 10g. The power feedback switches 191 to 194 are provided in tandem with the diodes 171 to 174. The power feedback switches 191 to 194 are n-MOS type FETs.

When the voltage V exceeds the voltage Vo, a voltage control circuit 153g included in a driving circuit 15g switches on all of the power feedback switches 191 to 194 at the same time, to feed back power from the load to the power source 5 through the step-up circuit 10g.

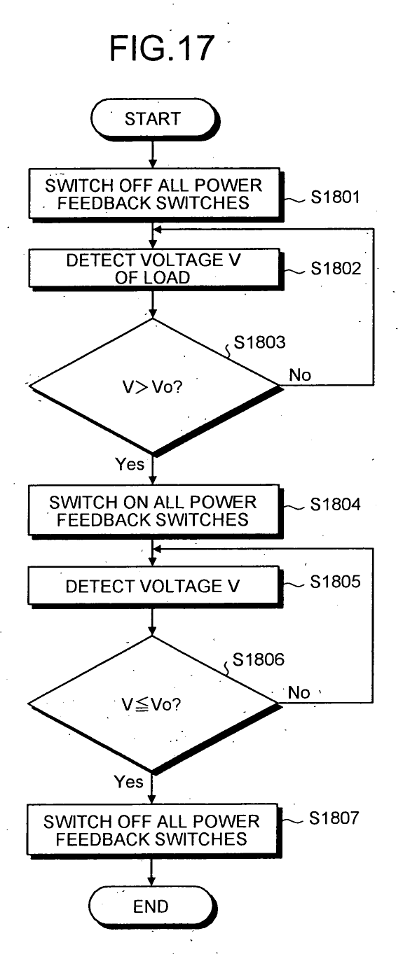

FIG. 17 is a flowchart of a power feedback procedure performed by the power unit 1g. When the power unit 1g is booted, the voltage control circuit 153g switches off the power feedback switches 191 to 194 (step S1801). The voltage detecting circuit 152 detects a voltage V of the load 20 (step S1802). The voltage control circuit 153g checks whether the voltage V exceeds the voltage Vo (step S1803). When the voltage V does not exceed the voltage Vo (No at step S1803), the procedure returns to step S1802 to detect the voltage V. On the other hand, when the voltage V exceeds the voltage Vo (Yes at step S1803), the voltage control circuit 153g switches on the power feedback switches 191 to 194 (step S1804).

The voltage detecting circuit 152 detects the voltage V (step S1805). The voltage control circuit 153g checks whether the voltage V is equal to or less than the voltage Vo (step S1806). When the voltage V is not equal to or less than the voltage Vo (No at step S1806), the procedure returns to step S1805. On the other hand, when the voltage V is equal to or less than the voltage Vo (Yes at step S1806), the voltage control circuit 153g switches off the power feedback switches 191 to 194 (step S1807), and the procedure ends.

Accordingly, while power is fed back from the load 20 to the power source 5 through the step-up circuit 10g, an overvoltage breakdown in a smoothing capacitor is prevented. Therefore, failures in the circuit components are prevented so that a stable voltage supply is obtained.

Furthermore, when the voltage V exceeds the voltage Vo, the voltage control circuit 153g grounds the second terminals of all of the capacitors 161, 162, and 163. Therefore, an overvoltage breakdown in a smoothing capacitor is prevented so that failures in the circuit components are prevented. As a result, a stable voltage supply is obtained.

Moreover, the voltage control circuit 153g controls the on-switches 1812, 1822, and 1832, and the off-switches 1813, 1823, and 1833 using the PWM technique, so that the power is gradually fed back from the load 20 to the power source 5. Therefore, loads on the semiconductor switches, harnesses, and so forth, are alleviated.

The present invention is not limited to the embodiments described above. Various changes may be made without departing from the scope of the present invention.

The voltage detecting circuit and the voltage control circuit are hardware components in the embodiments. However, these circuits can be implemented as software components.

The power sources 5, the charge-pump power sources 1811, 1821, and 1831 are provided separately in the seventh and eighth embodiments. However, a single power source can be employed instead of these power sources.

The power feedback switches and the switches are n-MOS type FET semiconductor switches in the embodiments. However, these switches can be electromagnetic-mechanical switches in an electromagnetic relay.

In the second and third embodiments, the first switch 106, the second switch 116, and the switch 140 are connected to the coils 101 or 111 at the terminal that is connected to the power source 5. Alternatively, the first switch 106, the second switch 116, and the switch 140 can be connected to the other terminals, terminals that are not connected to the power source, of the coils 101 or 111.

All the automatic processes explained in the present embodiment can be, entirely or in part, carried out manually. Similarly, all the manual processes explained in the present embodiment can be entirely or in part carried out automatically by a known method. The sequence of processes, the sequence of controls, specific names, and data including various parameters can be changed as required unless otherwise specified.

The constituent elements of each power unit illustrated are merely conceptual and may not necessarily physically resemble the structures shown in the drawings. For instance, the unit need not necessarily has the structure that is illustrated. The unit as a whole or in parts can be broken down or integrated either functionally or physically in accordance with the load or how the unit is to be used. The process functions performed by the unit are entirely or partially realized by the CPU or a program executed by the CPU or by a hardware using wired logic.

The voltage control method according to the embodiment of the present invention can be implemented on a computer by executing a computer program. The computer program can be stored in a computer-readable recording medium such as ROM, HD, FD, CD-ROM, CD-R, CD-RW, MO, DVD, and so forth, or can be downloaded via a network such as the Internet. The connection between the power unit and the network can be wired or wireless.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A power unit comprising:
a power source;
a load;
a step-up circuit that connects the power source and the load and includes
a plurality of voltage step-up circuits, wherein the voltage step-up circuits step up a voltage of the power source to a predetermined voltage and apply the predetermined voltage to the load; and
a power feedback unit that feeds back power from the load to the power source;
a voltage detecting unit that detects a voltage of the load; and
a voltage control unit that controls the voltage step-up circuits so as to be cyclically driven one after the other, and controls the power feedback unit to feed back power from the load to the power source when a voltage of the load detected by the voltage detecting unit exceeds the predetermined voltage.

2. The power unit according to claim 1, wherein the voltage step-up circuit is a chopper-type step-up circuit.

3. The power unit according to claim 2, wherein
each of the plurality of the chopper-type step-up circuits includes
a coil having first and second terminals, the first terminal being connected to the power source;
a step-up switch having first to third terminals, the first terminal being connected to the voltage control unit, the second terminal being connected to the second terminal of the coil, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch, and
in a state that at least a first step-up switch from among the step-up switches in the chopper-type step-up circuits is in an on state, when the voltage of the load detected by the voltage detecting unit exceeds the predetermined voltage, the voltage control unit switches off the first step-up switch, and switches on a power feedback switch of a chopper-type step-up circuit that includes a step-up switch that is in an off state other than the first step-up switch.

4. The power unit according to claim 2, wherein
each of the plurality of the chopper-type step-up circuits includes
a switch having first to third terminals, the first terminal being connected to the voltage control unit and the third terminal being connected to the power source;
a coil having first and second terminals, the first terminal being connected to the second terminal of the switch;
a step-up switch having first to third terminals, the first terminal being connected to the voltage control unit, the second terminal being connected to the second terminal of the coil, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch, and
in a state that all of the switches in the chopper-type step-up circuits are in an on state and at least a first step-up switch from among the step-up switches in the chopper-type step-up circuits is in an on state, when the voltage of the load detected by the voltage detecting unit exceeds the predetermined voltage, the voltage control unit switches off a switch of a chopper-type step-up circuit that includes the first step-up switch, and switches on a power feedback switch of a chopper-type step-up circuit that includes a step-up switch that is in an off state other than the first step-up switch.

5. The power unit according to claim 2, wherein
each of the plurality of the chopper-type step-up circuits includes
a coil having first and second terminals, the first terminal being connected to the power source;
a switch having first to third terminals, the first terminal being connected to the voltage control unit and the third terminal being connected to the second terminal of the coil;
a step-up switch having first to third terminals, the first terminal being connected to the voltage control unit, the second terminal being connected to the second terminal of the switch, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the switch and the second terminal of the step-up switch, and
in a state that all of the switches in the chopper-type step-up circuits are in an on state and at least a first step-up switch from among the step-up switches in the chopper-type step-up circuits is in an on state, when the voltage of the load detected by the voltage detecting unit exceeds the predetermined voltage, the voltage control unit switches off a switch of a chopper-type step-up circuit that includes the first step-up switch, and switches on a power feedback switch of a chopper-type step-up circuit that includes a step-up switch that is in an off state other than the first step-up switch.

6. The power unit according to claim 2, wherein
the chopper-type step-up circuits include a first chopper-type step-up circuit and at least one second chopper-type step-up circuit, and the step-up circuit further includes a switch, wherein
the switch has first to third terminals, the first terminal being connected to the voltage control unit, the third terminal being connected to the power source,
the first chopper-type step-up circuit includes
a coil having first and second terminals, the first terminal being connected to the power source and the third terminal of the switch;
a step-up switch having first to third terminals, the first terminal being connected to the voltage control unit, the second terminal being connected to the second terminal of the coil, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch,
the second chopper-type step-up circuit includes
a coil having first and second terminals, the first terminal being connected to the second terminal of the switch and the second terminal being connected to the load and
a step-up switch having first to third terminals, the first terminal being connected to the voltage control unit, the second terminal being connected to the second terminal of the coil and the load, and the third terminal being connected to the power source and the load, and
in a state that the switch is in an on state, when the voltage of the load detected by the voltage detecting unit exceeds the predetermined voltage, the voltage control unit switches off the switch and switches on the power feedback switch of the first chopper-type step-up circuit.

7. The power unit according to claim 2, wherein
the chopper-type step-up circuits include a first chopper-type step-up circuit and at least one second chopper-type step-up circuit, wherein
the first chopper-type step-up circuit includes
a coil having first and second terminals, the first terminal being connected to the power source;
a step-up switch having first to third terminals, the first terminal being connected to the voltage control unit, the second terminal being connected to the second terminal of the coil, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch,
the second chopper-type step-up circuit includes
a coil having first and second terminals, the first terminal being connected to the power source and the second terminal being connected to the load;
a switch having first to third terminals, the first terminal being connected to the voltage control unit and the third terminal being connected to the second terminal of the coil; and
a step-up switch having first to third terminals, the first terminal being connected to the voltage control unit, the second terminal being connected to the second terminal of the switch and the load, and the third terminal being connected to the power source and the load, and
in a state that the switch of the second chopper-type step-up circuit is in an on state, when the voltage of the load detected by the voltage detecting unit exceeds the predetermined voltage, the voltage control unit switches off the switch and switches on the power feedback switch of the first chopper-type step-up circuit.

8. The power unit according to claim 2, wherein the step-up circuit further includes a power feedback circuit, wherein
the power feedback circuit includes the power feedback unit that includes a power feedback switch, the power feedback switch having first to third terminals, the first terminal being connected to the voltage control unit, the second terminal being connected to the load, and the third terminal being connected to the power source,
each of the plurality of the chopper-type step-up circuits includes
a coil having first and second terminals, the first terminal being connected to the power source and the second terminal being connected to the load and
a step-up switch having first to third terminals, the first terminal being connected to the voltage control unit, the second terminal being connected to the second terminal of the coil and the load, and the third terminal being connected to the power source and the load, and
when the voltage of the load detected by the voltage detecting unit exceeds the predetermined voltage, the voltage control unit switches on the power feedback switch of the power feedback circuit.

9. The power unit according to claim 2, further comprising a power source corresponding to each of the plurality of the chopper-type step-up circuits, wherein
each of the plurality of the chopper-type step-up circuits includes
a coil having first and second terminals, the first terminal being connected to a corresponding power source;
a step-up switch having first to third terminals, the first terminal being connected to the voltage control unit, the second terminal being connected to the second terminal of the coil, and the third terminal being connected to any one of the power sources and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch, and
when the voltage of the load detected by the voltage detecting unit exceeds the predetermined voltage, the voltage control unit switches on a power feedback switch of a chopper-type step-up circuit that includes a step-up switch in an off state.

10. The power unit according to claim 2, wherein
the chopper-type step-up circuits include a first chopper-type step-up circuit and at least one second chopper-type step-up circuit, and the step-up circuit further includes a switch, wherein
the switch has first to third terminals, the first terminal being connected to the voltage control unit, the second terminal being connected to the power source,
the first chopper-type step-up circuit includes
a coil having first and second terminals, the first terminal being connected to the power source and the second terminal of the switch;
a step-up switch having first to third terminals, the first terminal being connected to the voltage control unit, the second terminal being connected to the second terminal of the coil, and the third terminal being connected to the power source and the load; and
the power feedback unit that includes a power feedback switch, the power feedback switch having first to third terminals, the first terminal being connected to the voltage control unit, the second terminal being connected to the load, and the third terminal being connected to the second terminal of the coil and the second terminal of the step-up switch,
the second chopper-type step-up circuit includes
a coil having first and second terminals, the first terminal being connected to the third terminal of the switch and the second terminal connected to the load and
a step-up switch having first to third terminals, the first terminal being connected to the voltage control unit, the second terminal being connected to the second terminal of the coil and the load, and the third terminal being connected to the power source and the load, and
in a state that the switch is in an on state, when the voltage of the load detected by the voltage detecting unit exceeds the predetermined voltage, the voltage control unit switches off the switch and switches on the power feedback switch of the first chopper-type step-up circuit.

11. The power unit according to claim 1, wherein the voltage step-up circuit is a charge-pump circuit.

12. The power unit according to claim 11, wherein the power unit further includes a power feedback circuit, wherein
the power feedback circuit includes
the power feedback unit that includes a power feedback switch, the power feedback switch having first to third terminals, the first terminal being connected to the voltage control unit, the second terminal being connected to the load, and the third terminal being connected to the power source,
each of the plurality of the charge-pump circuits include
a capacitor having first and second terminals, the second terminal being connected to the power source and the load;
a charge-pump power source having first and second terminals, the first terminal being connected to the power source and the load; and
a changeover switch having first to fourth terminals, the first terminal being connected to the voltage control unit, the second terminal being connected to the second terminal of the charge-pump power source, the third terminal being connected to the first terminal of the capacitor, and the fourth terminal being connected to the power source and the load, and
when the voltage of the load detected by the voltage detecting unit exceeds the predetermined voltage, the voltage control unit switches on the power feedback switch of the power feedback circuit.

13. The power unit according to claim 11, wherein the step-up circuit further includes a plurality of the power feedback units each including a power feedback switch, wherein
a power feedback switch closest to the power source has first to third terminals, the first terminal being connected to the voltage control unit and the third terminal being connected to the power source,
a power feedback switch closest to the load has first to third terminals, the first terminal being connected to the voltage control unit and the second terminal being connected to the load,
a power feedback switch connecting the power feedback switch closest to the power source and the power feedback switch closest to the load has first to third terminals, the first terminal being connected to the voltage control unit, the second terminal being connected to the third terminal of the power feedback switch closest to the load or another power feedback switch between the power feedback switch closest to the power source and the power feedback switch closest to the load, and the third terminal being connected to the second terminal of the power feedback switch closest to the power source or another power feedback switch between the power feedback switch closest to the power source and the power feedback switch closest to the load,
each of the plurality of the charge-pump circuits include
a capacitor having first and second terminals, the second terminal being connected to the second terminal of the power feedback switch or the third terminal of another power feedback switch;
a charge-pump power source having first and second terminals, the first terminal being connected to the power source and the load; and
a changeover switch having first to fourth terminals, the first terminal being connected to the voltage control unit, the second terminal being connected to the second terminal of the charge-pump power source, the third terminal being connected to the first terminal of the capacitor, and the fourth terminal being connected to the power source and the load, and
when the voltage of the load detected by the voltage detecting unit exceeds the predetermined voltage, the voltage control unit switches on all of the power feedback switches.

14. The power unit according to claim 12, wherein the voltage control unit grounds the first terminal of the capacitor in all of the charge-pump circuits, when the voltage of the load detected by the voltage detecting unit exceeds the predetermined voltage.

15. The power unit according to claim 13, wherein the voltage control unit grounds the first terminal of the capacitor in all of the charge-pump circuits, when the voltage of the load detected by the voltage detecting unit exceeds the predetermined voltage.

16. The power unit according to claim 12, wherein the voltage control unit controls the changeover switch using a pulse-width modulation technique.

17. The power unit according to claim 13, wherein the voltage control unit controls the changeover switch using a pulse-width modulation technique.

18. The power unit according to claim 1, wherein the power feedback unit is any of a semiconductor switch and an electromagnetic-mechanical switch.

19. The power unit according to claim 1, wherein the switch is a semiconductor switch or an electromagnetic-mechanical switch.

20. The power unit according to claim 1, wherein the voltage control unit controls the power feedback switch using a pulse-width modulation technique.

21. A method of controlling a voltage in a power unit, the power unit including a power source, a load, and a step-up circuit connecting the power source and the load, wherein the step-up circuit includes a plurality of voltage step-up circuits and a power feedback unit, comprising:
stepping up a voltage of the power source to a predetermined voltage and applying the predetermined voltage to the load;
feeding back power from the load to the power source;
detecting a voltage of the load; and
controlling the voltage step-up circuits so as to be cyclically driven one after the other, and the power feedback unit to feed back power from the load to the power source when a voltage of the load detected at the detecting exceeds the predetermined voltage.

22. A computer-readable recording medium that stores therein a computer program that causes a computer to control a voltage in a power unit, the power unit including a power source, a load, and a step-up circuit connecting the power source and the load, wherein the step-up circuit includes a plurality of voltage step-up circuits and a power feedback unit, the computer program causing the computer to execute:
stepping up a voltage of the power source to a predetermined voltage and applying the predetermined voltage to the load;
feeding back power from the load to the power source;
detecting a voltage of the load; and
controlling the voltage step-up circuits so as to be cyclically driven one after the other, and the power feedback unit to feed back power from the load to the power source when a voltage of the load detected at the detecting exceeds the predetermined voltage.
